(19) United States
(12) Patent Application Publication
(10) Pub. No.: US 2026/0318767 A1
(43) Pub. Date: Oct. 15, 2026

(54) TORQUE SENSOR MODULE

(71) Applicant: AL ROBOT CO., LTD., Gyeonggi-do (KR)

(72) Inventors: Daehee KANG, Incheon (KR); Seogyeon HAN, Gyeonggi-do (KR)

(21) Appl. No.: 19/483,990

(22) PCT Filed: Mar. 12, 2024
(86) PCT No.: PCT/KR2024/003168

§ 371 Date: Nov. 13, 2025

(30) Foreign Application Priority Data
May 22, 2023 (KR) 1020230065892

(51) Int. Cl. G01L 25/00; G01L 5/00; G01L 5/1627

(52) U.S. Cl. CPC G01L 25/003; G01L 5/0066; G01L 5/1627

(57) ABSTRACT

Torque sensor module disclosed. There is provided a method for obtaining a calibration gain for strain gauges of a torque sensor module in advance, enabling precise detection of force and torque about one or multiple axes, and allowing accurate control of robot joints such as an arm, neck, or wrist. The invention further provides a torque sensor module in which the calibration gain is applied to perform torque control of a robot joint.

### TECHNICAL FIELD

The present invention relates to a torque sensor module, and more particularly, to a torque sensor module in which a calibration gain for strain gauges of a designed torque sensor module is pre-obtained and applied to torque control.

### BACKGROUND ART

In the case of industrial robots, a torque sensor mounted on a robot's wrist or the like is generally used to measure the force applied to a work object by a tool mounted on the robot arm. However, mounting a torque sensor on a robot's joint can complicate dynamic analysis and lead to accumulated errors, which is why this method is being researched more in the field of intelligent service robots than industrial robots.

When a robot arm or other part collides with an external object or person, it is impossible to detect collision, making it difficult to ensure safety through an active response. Since most intelligent robots currently in use must perform tasks in unknown and uncontrolled environments, they must operate with the safety of the robot and people as the top priority compared to industrial robots. For example, in a robot arm or similar device, it may be necessary to detect and precisely control a rotational force about one axis in a rectangular coordinate system, that is, a z-axis torque Tz on an xy plane, even under the influence of crosstalk such as a bending force resulting from external mechanical interference, including pushing or impact by a person. In certain cases, it may also be necessary to detect and precisely control multi-axis forces or torques in various directions, such as those occurring in a neck or a wrist.

Accordingly, the present disclosure proposes a torque sensor module configured to detect a force or torque applied to a robot joint and to enable precise control of the robot.

As related prior art, documents such as KR Patent Application No. 10-2009-0115343 (Nov. 26, 2009) may be referred to.

### SUMMARY OF THE INVENTION

### Objects of the Invention

Therefore, the present invention has been devised to solve the aforementioned problems, and intended to provide a method for pre-obtaining a calibration gain for strain gauges of a torque sensor module, in order to precisely detect force and torque about one or more axes and enable precise control of robot joints such as a robot arm, neck, or wrist, and to provide a torque sensor module to which the calibration gain is applied, thereby enabling torque control at the robot joint.

### Means for Solving the Problems

First, to summarize the features of the present invention, a calibration method in an apparatus for analyzing an operation of a torque sensor module according to one aspect of the present invention for achieving the above object may include: receiving, in response to an input torque, sensing voltages from a plurality of strain gauges mounted on the torque sensor module, wherein each sensing voltage is obtained from a contact point of a pair of strain gauges attached at respective positions and connected in series; calculating a differential component having first difference values between a reference voltage and each of the sensing voltages and second difference values for each of two combinations of the sensing voltages; calculating a calibration gain corresponding to the input torque and the differential component; and applying the calibration gain to a circuitry of the torque sensor module to calculate a torque received by the torque sensor module based on the calibration gain.

The input torque may include a value for one or more forces or torques along the three axes of a rectangular coordinate system.

In the calculating the calibration gain, the calibration gain may be calculated to satisfy T-AS=k, where T is the input torque, A is the calibration gain, S is the differential component, and k is zero or a real value predetermined for calibration.

The calibration gain may be determined based on a result of regression analysis or neural network learning, performed while varying values of the input torque, such that the calibration gain satisfies a predetermined minimum value.

And a torque sensor module circuit according to another aspect of the present invention for achieving the above object may include: a reference voltage generator; a memory configured to store a calibration gain; a torque detector configured to: receive sensing voltages from a plurality of strain gauges mounted on a torque sensor module, wherein each sensing voltage is received from a contact point of a pair of strain gauges attached at respective positions and connected in series; calculate a differential component having first difference values between a reference voltage from the reference voltage generator and each of the sensing voltages, and second difference values for each of two combinations of the sensing voltages; and calculate a torque corresponding to the differential component and the calibration gain; and a torque controller configured to generate a command for torque control based on the calculated torque, wherein the calibration gain is pre-calculated to correspond to the input torque and the differential component for each of the sensing voltages in the torque sensor module for a predetermined input torque and stored in the memory.

The torque sensor module may include: a body in which a first sensitivity adjustment hole, a strain measurement hole, a second sensitivity adjustment hole, and a stiffness adjustment hole are repeatedly formed along a circumferential direction between a central hole and an outer circumferential surface, wherein the strain measurement hole, to which the pair of strain gauges are attached, has a trapezoidal shape with a side closer to the center having a greater length than a side closer to the outer circumferential surface.

### Effects of the Invention

According to the torque sensor module of the present invention, a calibration gain for strain gauges, which are configured through a combination of six strain gauges forming three full-bridge configurations and three half-bridge configurations, can be pre-obtained (obtained in advance), and by applying the calibration gain to the torque sensor module, it becomes possible to precisely detect force and torque about one or more axes and to enable precise control of robot joints, such as a robot arm, neck, or wrist.

Accordingly, a high-performance torque sensor module can be implemented by precisely applying sensor data from strain gauges. For example, the module can assist in precisely controlling rotational force on an xy plane, that is, z-axis torque Tz, even under the influence of crosstalk such as z-axis bending force resulting from external mechanical interference, including pushing or impact by a person. In certain cases, the torque sensor module may be applied to robot joints, such as a neck or wrist, in which multi-axis (e.g., six-axis) force or torque is controlled, thereby assisting in precise control of such force or torque.

### BRIEF DESCRIPTION OF THE DRAWINGS

The accompanying drawings, which are included as part of the detailed description to aid in understanding the present invention, illustrate embodiments of the present invention and, together with the detailed description, serve to explain the principles of the invention.

FIG. 1 is a perspective view of a torque sensor module 100 according to an embodiment of the present invention;

FIG. 2 is a front view of the torque sensor module 100 shown in FIG. 1;

FIG. 3 illustrates the connection configuration of strain gauges {(SG1, SG2), (SG3, SG4), (SG5, SG6)} according to the present invention;

FIG. 4 is a flowchart illustrating a calibration method performed by an apparatus for analyzing the operation of the torque sensor module 100 according to an embodiment of the present invention;

FIG. 5 shows multi-axis direction components of a force or torque received by the torque sensor module 100 of the present invention; and

FIG. 6 is a block diagram of a circuit configuration of the torque sensor module 100 of the present invention.

### DETAILED DESCRIPTION OF THE EMBODIMENTS

Hereinafter, the present invention will be described in detail with reference to the accompanying drawings. In the drawings, like elements are denoted by like reference numerals. Detailed descriptions of functions and/or configurations already known in the art will be omitted. The following description focuses on aspects necessary for understanding the operation of various embodiments, and omits descriptions of elements that may obscure the essence of the invention. Furthermore, some elements in the drawings may be exaggerated, omitted, or illustrated schematically. The sizes of the elements do not necessarily reflect their actual dimensions, and therefore, the relative sizes or spacing shown in the drawings should not be construed as limiting the scope of the present disclosure.

In describing embodiments of the present invention, detailed descriptions of known technologies related to the present invention may be omitted where it is deemed that such descriptions would unnecessarily obscure the gist of the invention. The terms used herein are defined in consideration of the functions of the present invention and may vary depending on the intent of a user, operator, or customary usage. Therefore, the definitions should be interpreted in accordance with the overall disclosure of this specification. The terminology used in the detailed description is intended solely for the purpose of describing embodiments of the present invention and is not intended to be limiting. Unless explicitly stated otherwise, the singular forms also include the plural forms. As used herein, terms such as “include” or “comprise” are intended to specify the presence of stated features, integers, steps, operations, elements, components, or combinations thereof, but do not preclude the presence or addition of one or more other features, integers, steps, operations, elements, components, or combinations thereof.

In addition, terms such as “first,” “second,” and the like may be used to describe various elements, but such terms should not be construed as limiting. These terms are merely used to distinguish one element from another.

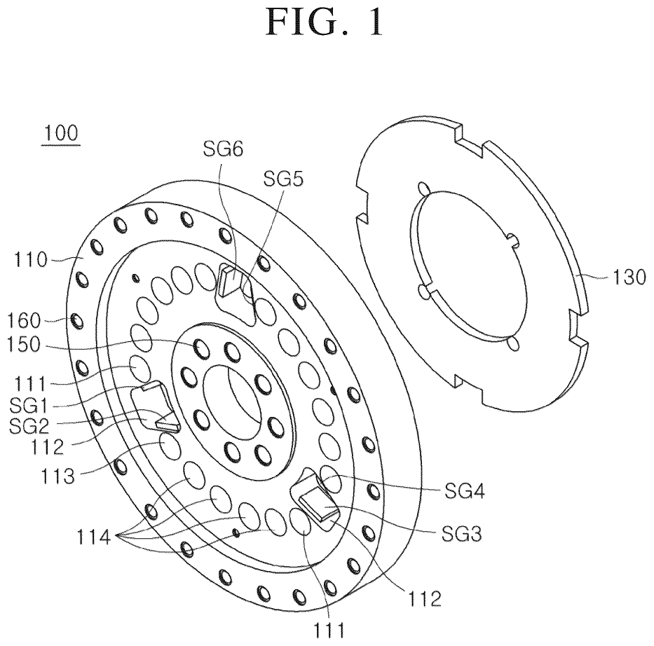

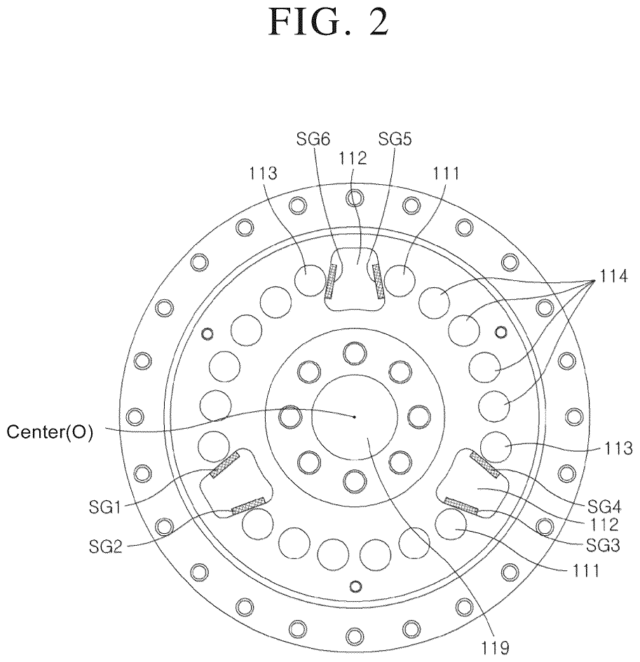

FIG. 1 is a perspective view of a torque sensor module 100 according to an embodiment of the present invention. FIG. 2 is a front view of the torque sensor module 100 shown in FIG. 1.

Referring to FIGS. 1 and 2, a torque sensor module 100 according to an embodiment of the present invention may include a circular body 110 having a certain thickness, a pair of strain gauges {(SG1, SG2), (SG3, SG4), (SG5, SG6)} attached to each of a plurality of strain measurement holes 112 of the body 110, and a circuit board 130 connected to signal lines from each strain gauge of the strain gauge pairs {(SG1, SG2), (SG3, SG4), (SG5, SG6)} attached to each of the plurality of strain measurement holes 112. Preferably, three pairs of strain gauges {(SG1, SG2), (SG3, SG4), (SG5, SG6)} are provided, but additional strain measurement holes 112 and corresponding pairs of strain gauges may be added as needed.

As illustrated in FIG. 1, the circuit board 130 may be manufactured in the form of a ring-type Printed Circuit Board (PCB) and may be mounted on either lateral surface of the body 110. The circuit board 130 is designed and mounted such that no portion of the circuit board 130 obstructs the central hole 119 of the body 110, allowing the central hole 119 to remain open. Through the central hole 119, the torque sensor module may be mounted on a predetermined shaft provided on an arm of a robot or similar structure, which is configured to detect and control torque about one axis in a Cartesian coordinate system, specifically z-axis torque Tz. The circuit board 130 may include circuit components such as an amplifier, an Analog-to-Digital (AD) converter, and an arithmetic unit for digitally processing sensing signals from the signal lines of each strain gauge {(SG1, SG2), (SG3, SG4), (SG5, SG6)} to calculate torque values.

Here, an exemplary structure of the torque sensor module 100 according to an embodiment of the present invention is described for illustrative purposes only. It should be understood that the structures of the body 110, the plurality of strain measurement holes 112 formed in the body 110, or other holes may take various shapes or configurations.

As shown in FIGS. 1 and 2, the body 110 includes a first sensitivity adjustment hole 111, the strain measurement hole 112, a second sensitivity adjustment hole 113, and a rigidity adjustment hole 114 disposed along the circumferential direction between the central hole 119 and the outer circumferential surface, and a hole array consisting of the first sensitivity adjustment hole 111, the strain measurement hole 112, the second sensitivity adjustment hole 113, and the rigidity adjustment hole 114 is formed by repeating the same sequence two or more times.

One or, preferably, a plurality of rigidity adjustment holes 114 are formed between the second sensitivity adjustment hole 113 and the first sensitivity adjustment hole 111, and may be formed in an appropriate number to appropriately reduce the overall weight while maintaining the rigidity of the sensor module 100.

The first sensitivity adjustment hole 111 and the second sensitivity adjustment hole 113 are each formed on both sides of the strain measurement hole 112 in the circumferential direction at a certain distance from the strain measurement hole 112, and the plurality of rigidity adjustment holes 114 may be formed at positions spaced apart by a certain pitch in the circumferential direction. Each hole located at both ends of the plurality of rigidity adjustment holes 114 can be formed to be spaced apart from the first sensitivity adjustment hole 111 or the second sensitivity adjustment hole 113 by a certain distance.

Each strain measurement hole 112 serves as a mounting location for a strain gauge pair {(SG1, SG2), (SG3, SG4), (SG5, SG6)} configured to measure strain applied to the torque sensor module 100 at its installed position, and as shown in the drawings, each strain gauge pair {(SG1, SG2), (SG3, SG4), (SG5, SG6)} is respectively attached to opposing side wall surfaces of each strain measurement hole 112, along the circumferential direction, so as to face each other.

The first sensitivity adjustment hole 111 and the second sensitivity adjustment hole 113, which are symmetrically positioned on each side of the strain measurement hole 112, are located at certain distances in the circumferential direction and are appropriately sized to enable the strain gauges {(SG1, SG2), (SG3, SG4), (SG5, SG6)} to generate detection signals by measuring a suitable strain rate (or strain) at the corresponding locations.

In addition, it is advantageous for strain rate measurement of the strain gauges {(SG1, SG2), (SG3, SG4), (SG5, SG6)} by forming the strain measurement hole 112 in a trapezoidal shape in which the central side is longer than the outer circumferential side. Since the sensitivity of the strain gauges {(SG1, SG2), (SG3, SG4), (SG5, SG6)} may vary depending on their placement, the distance from the first sensitivity adjustment hole 111 and the second sensitivity adjustment hole 113, the size of the holes, it is preferrable that the distance from the first sensitivity adjustment hole 111 and the second sensitivity adjustment hole 113 and the size of the holes must be formed at an appropriate distance and size according to the purpose, and the slopes of both side walls in the circumferential direction of the trapezoidal shape to which the strain gauges {(SG1, SG2), (SG3, SG4), (SG5, SG6)} are attached also have an appropriate symmetrical slope.

Also, the first sensitivity adjustment hole 111, the second sensitivity adjustment hole 113, and the rigidity adjustment hole 114 are illustrated as being circular, but are not limited thereto, and may be formed in various shapes such as circles, ellipses, or polygons such as trapezoids, triangles, squares, and pentagons. The plurality of rigidity adjustment holes 114 may be formed at positions spaced apart by a certain pitch in the circumferential direction. A suitable number of rigidity adjustment holes 114 may be formed between the second sensitivity adjustment hole 113 and the first sensitivity adjustment hole 111, with appropriate size and spacing, so as to maintain a certain level of rigidity. Unlike the prior art (e.g., Patent Application No. 10-2009-0115343), in which stiffness adjustment holes are formed between spoke-type wheel arms with relatively many openings between the spokes, the stiffness adjustment hole 114 of the present invention is formed on a surface of the body 110 that extends to the outer circumferential edge. In this configuration, spokes are positioned between the holes, resulting in a larger spoke area compared to the prior art. This structure allows the torque sensor module 100 to maintain its overall shape more effectively than the spoke-type design.

Furthermore, as in FIGS. 1 and 2, it is preferable that the centers of the first sensitivity adjustment hole 111, the second sensitivity adjustment hole 113, and the rigidity adjustment holes 114 are arranged on the same first radial distance r1 from the center O of the body 110. Accordingly, it is possible to provide strain sensor information for deformation in any direction in a balanced manner.

The trapezoidal strain measurement hole 112 may be formed such that its center is located at the same first radial distance r1 from the center O, that is, along the same arc centered on O, as the first sensitivity adjustment hole 111, the second sensitivity adjustment hole 113, and the stiffness adjustment hole 114. However, this configuration is not limited thereto, and the strain measurement hole 112 may alternatively be arranged such that an arc at the same radial distance r1 from the center O intersects at least a portion of the inner area of the trapezoidal shape, excluding its four edges.

In addition, the sensitivity of the strain gauges {(SG1, SG2), (SG3, SG4), (SG5, SG6)} may vary depending on their placement on the opposing side walls of the strain measurement hole 112. For example, when the trapezoidal strain measurement hole 112 is formed such that its center lies on the same first radial distance r1 from the center O, that is, along the same arc centered on O, as the first sensitivity adjustment hole 111, the second sensitivity adjustment hole 113, and the stiffness adjustment hole 114, the center of the bottom surface of each of the strain gauges {(SG1, SG2), (SG3, SG4), (SG5, SG6)} may also be positioned on the same radial distance r1. However, preferably, the center of the bottom surface of each strain gauges {(SG1, SG2), (SG3, SG4), (SG5, SG6)} is positioned within the trapezoidal hole at a distance less than r1 from the center O. This is advantageous for strain detection, as the strain gauges {(SG1, SG2), (SG3, SG4), (SG5, SG6)} are located closer to the sensitivity adjustment holes 111 and 113.

In FIGS. 1 and 2, the stiffness adjustment holes 114 may be formed in an appropriate number to reduce the overall weight while maintaining the rigidity of the torque sensor module 100. Additionally, to further reduce weight, a suitable number of holes 150 may be formed in an extended surface region of the body 110 located at a second radial distance r2 from the center O, and additional holes 160 may be formed in another surface region located at a third radial distance r3 from the center O. These holes 111, 112, 113, 114, 150, and 160 may also be used for installing a cable for connection with the circuit board 130, or a cable or components for coupling with other accessories constituting a robot.

In particular, in the torque sensor module 100 of the present invention, a calibration matrix (or gain) A for the strain gauges {(SG1, SG2), (SG3, SG4), (SG5, SG6)}, configured through a combination of six strain gauges {(SG1, SG2), (SG3, SG4), (SG5, SG6)} forming three full-bridge and three half-bridge circuits, can be pre-obtained. By applying the calibration matrix A to the torque sensor module 100, precise detection of force and torque about a single axis or multiple axes is enabled, allowing for accurate control of robot joints such as an arm, neck, or wrist.

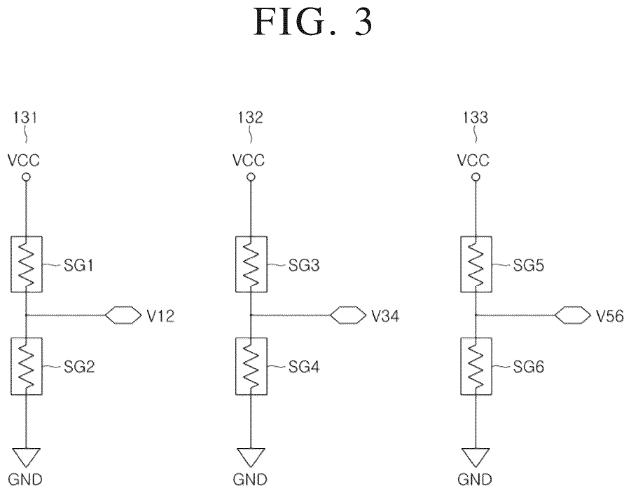

For this purpose, strain gauge pairs {(SG1, SG2), (SG3, SG4), (SG5, SG6)} attached to respective locations of the torque sensor module 100 are connected in series between a first power supply VCC and a second power supply GND, as shown in FIG. 3.

FIG. 3 illustrates the connection configuration of strain gauges {(SG1, SG2), (SG3, SG4), (SG5, SG6)} according to the present invention.

Referring to FIG. 3, a first power supply VCC and a second power supply GND are provided through the circuit board 130. Each pair of strain gauges {(SG1, SG2), (SG3, SG4), (SG5, SG6)} is connected in series, and the series connection may be implemented in one of two ways. In one configuration, connection lines from the respective terminals of the strain gauges are extended to the circuit board 130 and electrically connected there to form a contact point (or center tab). In another configuration, the connection lines are electrically connected outside the circuit board 130 to form the contact point, and then extended to the circuit board 130 to supply the corresponding voltage.

When the torque sensor module 100 is mounted on a robot joint or similar device and operates, sensing voltages V12, V34, and V56, each derived from the contact points of the strain gauge pairs {(SG1, SG2), (SG3, SG4), (SG5, SG6)} connected in series at respective locations, are provided to the circuit board 130. Based on these sensing voltages V12, V34, and V56 detected by the strain gauge pairs {(SG1, SG2), (SG3, SG4), (SG5, SG6)}, the circuit board 130 may perform torque control for the robot.

However, before the torque sensor module 100 is mounted on a robot joint or similar device and operates, a calibration gain A corresponding to the designed or manufactured torque sensor module 100 must be pre-obtained through an analysis apparatus (not shown) and applied to the circuitry of the circuit board 130. This enables the circuit board 130 to accurately calculate the torque received by the torque sensor module 100 based on the sensing voltages from the strain gauges.

Although the plurality of locations to which the strain gauges {(SG1, SG2), (SG3, SG4), (SG5, SG6)} are attached has been exemplarily described above as being attached to the strain measurement holes 112, the structure of the torque sensor module 100 for obtaining a calibration gain A may take various forms.

Accordingly, the attachment locations of the strain gauges {(SG1, SG2), (SG3, SG4), (SG5, SG6)} may vary depending on the structural configuration of the torque sensor module 100. For example, in a torque sensor module of another embodiment of the present invention, it is also possible that a pair of strain gauges are attached to each of a plurality of spokes (see Patent Application No. 10-2009-0115343) in a circumferential direction of a wheel spoke shape formed on a body 110 so as to face each other in the circumferential direction. Thus, the torque sensor module 100 is not limited to the structure shown in FIGS. 1 and 2. A calibration gain A corresponding to the designed or manufactured torque sensor module 100 may be pre-obtained through an analysis apparatus (not shown) and applied to the circuitry of the circuit board 130, so that the torque received by the torque sensor module 100 can be appropriately calculated based on the sensing voltages V12, V34, V56 from the strain gauges, regardless of the structural configuration.

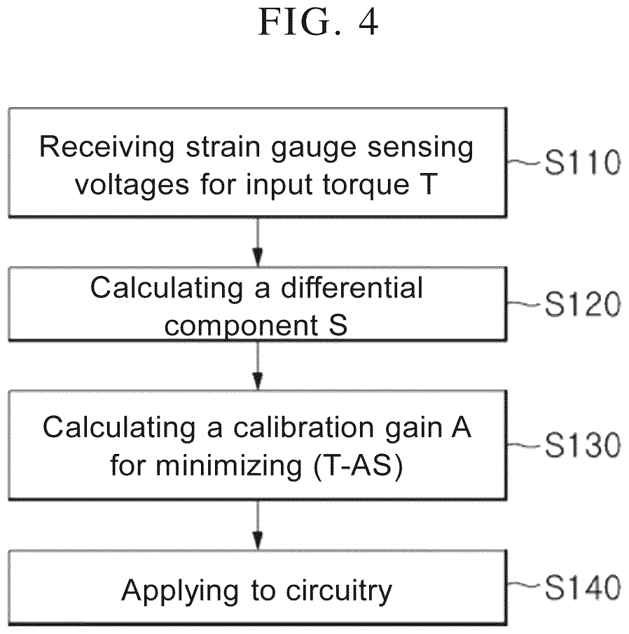

FIG. 4 is a flowchart illustrating a calibration method performed by an apparatus for analyzing the operation of the torque sensor module 100 according to an embodiment of the present invention.

Referring to FIG. 4, an analysis apparatus for analyzing the operation of the torque sensor module 100 may include step S110 of receiving sensing voltages V12, V34, V56 from the contact points of strain gauge pairs {(SG1, SG2), (SG3, SG4), (SG5, SG6)} in response to an input torque T applied to the torque sensor module 100, step S120 of calculating a differential component S, step S130 of calculating a calibration gain A, and step S140 of applying the calibration gain to the circuitry of the circuit board 130.

The step S110 of receiving sensing voltages V12, V34, V56 may include receiving each sensing voltage V12, V34, V56 from the contact points of strain gauge pairs {(SG1, SG2), (SG3, SG4), (SG5, SG6)} mounted at respective locations on the torque sensor module 100 and connected in series, after the input torque T is applied to the torque sensor module 100.

The input torque T refers to a force or torque applied to the torque sensor module 100, and may be applied to the torque sensor module 100 mounted on an actual robot or on a test apparatus. If necessary, steps S110 to S140 may also be performed on a simulated structure of the torque sensor module 100 for computer-based simulation.

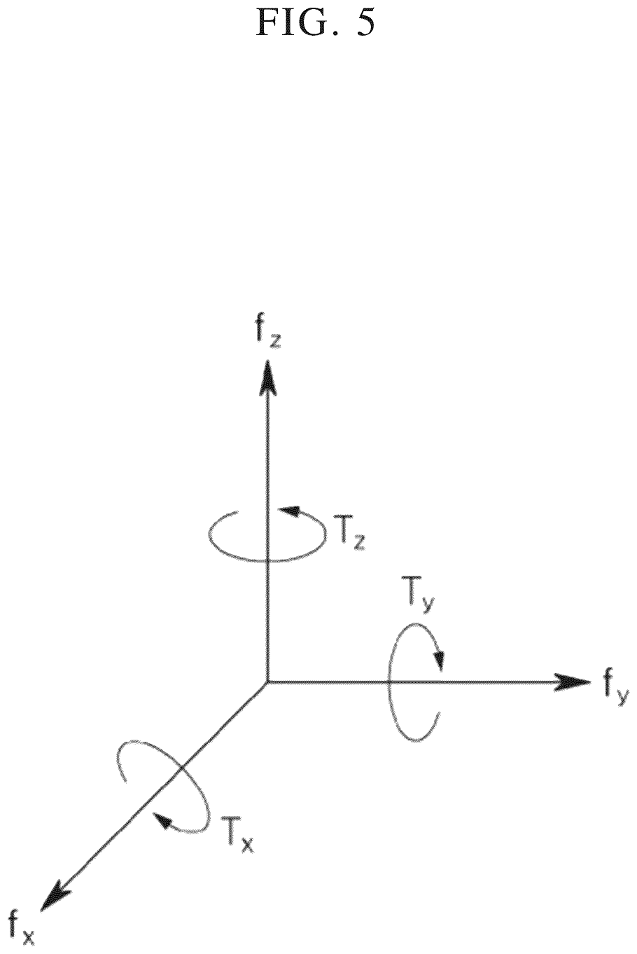

The input torque T may be represented as a matrix, as shown in Equation 1 below. The input torque T may be prepared in advance with predetermined values and applied to perform regression analysis or neural network-based learning, as described below. The input torque T may include values corresponding to one or more forces or torques along the three axes of a rectangular coordinate system (see FIG. 5).

T=[w1,w2,w3,w4,w5,Tz]^{T} T Equation 1

Where, a torque value Tz about one axis (e.g., the z-axis) of the three axes of a rectangular coordinate system may serve as a target torque value. In this case, w1 through w5 represent unwanted force or torque components, that is, crosstalk, that affect the torque output of the torque sensor module. These components may include torque components about other axes (e.g., x- and y-axes) or force components along each axis (e.g., x, y, and z axes). However, the configuration is not limited thereto. Specifically, w1 through w5 may correspond to an x-axis force component fx, a y-axis force component fy, a z-axis force component fz, an x-axis torque component Tx, and a y-axis torque component Ty, respectively. For example, calibration of the present invention may be performed to obtain the z-axis torque component Tz by treating w1 through w5 as crosstalk and Tz as the target torque. Furthermore, in addition to Tz, one or more of w1 through w5, i.e., force or torque components, may also be designated as meaningful target values for calibration (see FIG. 5).

Next, the step S120 of calculating a differential component S may include calculating first difference values VR12, VR34, VR56 between a reference voltage Vref and each of the sensing voltages V12, V34, V56, and second difference values V1234, V3456, V1256 based on respective combinations of two sensing voltages among V12, V34, and V56.

The differential component S may be represented as a matrix, as shown in Equation 2 and Equation 3 below. The differential component S may be calculated based on the sensing voltages V12, V34, V56 corresponding to each input torque T, and used to perform regression analysis or neural network-based learning, as described below.

S=[V1234,V3456,V1256,VR12,VR34,VR56]^{T} Equation 2

V1234=V12−V34V3456=V34−V56V1256=V12−V56VR12=Vref−V12VR34=Vref−V34VR56=Vref−V56 Equation 3

Here, each sensing voltage V12, V34, V56 constitutes a half-bridge configuration of a Wheatstone bridge. Accordingly, the first difference values VR12, VR34, VR56 between the reference voltage Vref and each sensing voltage are obtained by using three half-bridges, in which strain gauges are placed at two of the four resistor positions in the bridge. The second difference values V1234, V3456, V1256, calculated from combinations of the sensing voltages, are obtained by using full-bridge configurations, in which strain gauges are placed at all four resistor positions. Since methods for calculating torque values from sensing voltages corresponding to strain rates in Wheatstone bridge circuits incorporating strain gauge elements are well known, a detailed description thereof will be omitted (see KR Application No. 10-2023-0027956, filed Mar. 2, 2023).

Next, the step S130 of calculating a calibration gain A may include calculating the calibration gain A corresponding to the input torque T and the differential component S. The calibration gain A may be determined to satisfy Equation 4.

(T−AS)=k Equation 4

Where, k may correspond to an error value to be minimized, and may be set to zero or to another real number predetermined for calibration purposes.

That is, learning is performed while varying the values of the input torque T, and the calibration gain A is determined, as shown in Equation 5, based on the result of regression analysis or neural network-based learning, such that the calibration gain A satisfies the predetermined minimum value k. The neural network may be a convolutional neural network (CNN) or a deep neural network based thereon. For example, in the above case, the input torque T, the differential component S, and the minimum value k may each be m-dimensional column vectors (e.g., m=6), and the calibration gain A, represented as a matrix, may be a 6×6 matrix having elements A11 through A66, as shown in Equation 5.

$$A = [ \begin{matrix}A 11 , A 12 , A 13 , A 14 , A 15 , A 16 \\ A 21 , A 22 , A 23 , A 24 , A 25 , A 26 \\ A 31 , A 32 , A 33 , A 34 , A 35 , A 36 \\ A 41 , A 42 , A 43 , A 44 , A 45 , A 46 \\ A 51 , A 52 , A 53 , A 54 , A 55 , A 56 \\ A 61 , A 62 , A 63 , A 64 , A 65 , A 66\end{matrix} ] \qquad Equation 5$$

Next, the step S140 of applying to the circuit of the circuit board 130 may include applying the calibration gain A to the circuitry of the circuit board 130 so that the torque received by the torque sensor module 100 is calculated based on the calibration gain A. That is, the calibration gain A may be stored in a memory, such as ROM or RAM, of the circuit board 130 and used to calculate torque from the sensing voltages V12, V34, V56 according to the equation T=AS.

The analysis apparatus for analyzing the operation of the torque sensor module 100 of the present invention may be implemented in hardware, software, or a combination thereof. For example, it may be realized as a server or computing system including at least one processor configured to perform the above-described functions.

Such a computing system may include at least one processor, a memory, a user interface input device, a user interface output device, a storage, and a network interface, all connected via a bus. The processor may be a central processing unit (CPU) or a semiconductor device configured to execute instructions stored in the memory and/or storage. The memory and storage may include various types of volatile or non-volatile media. For example, the memory may include read-only memory (ROM) and random-access memory (RAM).

Therefore, steps of the method or algorithm described in connection with the embodiments disclosed herein may be directly implemented in hardware, as a software module executed by a processor as described above, or as a combination thereof. The software module may reside in a storage medium (i.e., memory and/or storage) such as RAM, flash memory, ROM, EPROM, EEPROM, a register, a hard disk, a removable disk, or a CD-ROM. An exemplary storage medium may be coupled to the processor, allowing the processor to read from and write to the storage medium. Alternatively, the storage medium may be integrated with the processor. The processor and storage medium may reside within an application-specific integrated circuit (ASIC), which may be embedded in a user terminal. Alternatively, the processor and storage medium may reside as discrete components within the user terminal.

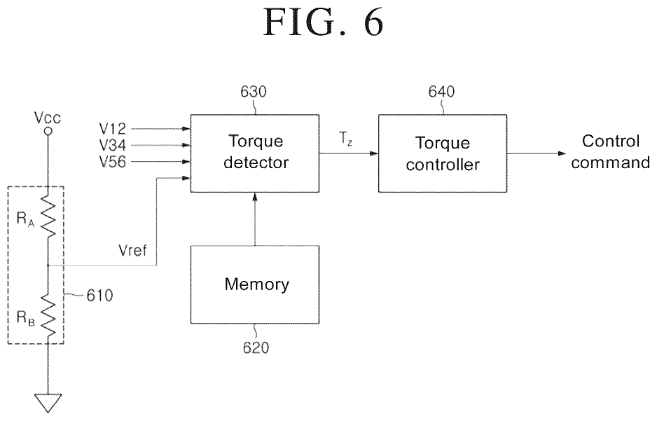

FIG. 6 is a block diagram of a configuration of the circuit board 130 of the torque sensor module 100 of the present invention.

Referring to FIG. 6, the circuitry of the circuit board 130 of the torque sensor module 100 according to the present invention may include a reference voltage generator 610 configured to generate a reference voltage Vref at a junction of resistors RA and RB connected in series between the first power source VCC and the second power source GND (e.g., Vref=VCC/2 when RA=RB); a memory 620, such as ROM or RAM, for storing a calibration gain A; a torque detector 630 configured to calculate torque (e.g., AS+k or AS) based on sensing voltages V12, V34, V56 from strain gauges, the reference voltage Vref, and the calibration gain A; and a torque controller 640 configured to generate torque control commands based on the torque calculated by the torque detector 630.

For example, the torque detector 630 may receive sensing voltages V12, V34, V56 from a plurality of strain gauges mounted on the torque sensor module 100. Each sensing voltage may be obtained from each contact point of pairs of strain gauges {(SG1, SG2), (SG3, SG4), (SG5, SG6)} connected in series and attached at respective positions. The torque detector 630 may calculate a differential component S including the first difference values between a reference voltage Vref, provided by the reference voltage generator 610, and each sensing voltage V12, V34, V56 and the second difference values based on combinations of two sensing voltages among V12, V34, and V56 (see Equations 2 and 3). Based on the differential component S and the calibration gain A (see Equation 5), the torque detector 630 may calculate torque values according to Equation 4 (e.g., AS+k or AS). The torque detector 630 may further include amplifiers for receiving the sensing voltages and analog-to-digital converters (ADCs) for converting the analog outputs of the amplifiers into digital signals.

That is, as described in FIG. 4, the calibration gain A is pre-calculated to correspond to the input torque T and the differential component S for each sensing voltage V12, V34, V56 in the torque sensor module 100, based on a certain input torque T, and is stored in the memory 620 for use.

The torque (′AS+k′ or ‘AS’) calculated by the torque detector 630 may correspond to the target torque value Tz about one axis (e.g., the z-axis) of a rectangular coordinate system. Among the calculated components, w1 through w5 represent unwanted force or torque components, i.e., crosstalk, that affect the torque value output of the torque sensor module. These may include torque components about other axes (e.g., x- and y-axes) or force components along each axis (e.g., x, y, and z), and may therefore be disregarded. However, the configuration is not limited thereto. Specifically, w1 through w5 may correspond to an x-axis force component fx, a y-axis force component fy, a z-axis force component fz, an x-axis torque component Tx, and a y-axis torque component Ty, respectively. For example, Tz may be obtained by treating w1 through w5 as crosstalk and designating the z-axis torque component Tz as the target torque. Furthermore, in addition to Tz, one or more of w1 through w5, i.e., force or torque components, may also be designated as meaningful target values to calculate corresponding torque outputs.

The torque controller 640 may generate a command for torque control of a robot joint or similar device based on the torque calculated by the torque detector 630, and may perform precise control over the movement of the robot joint or similar device.

As described above, in the torque sensor module 100 according to the present invention, a calibration matrix (or gain) A for the strain gauges {(SG1, SG2), (SG3, SG4), (SG5, SG6)} of the torque sensor module 100 designed using three full-bridge configurations and three half-bridge configurations through a combination of six strain gauges {(SG1, SG2), (SG3, SG4), (SG5, SG6)} can be pre-obtained, and by applying the calibration matrix A to the torque sensor module 100, it becomes possible to precisely detect force and torque about a single axis or multiple axes, thereby enabling precise control of robot joints such as an arm, neck, or wrist.

Accordingly, a high-performance torque sensor module 100 may be implemented by precisely applying sensor data from the strain gauges {(SG1, SG2), (SG3, SG4), (SG5, SG6)}. For example, it can assist in precisely controlling a rotational force on an xy plane, that is, a z-axis torque Tz, despite an influence of crosstalk such as a z-axis bending force caused by a person pushing or hitting it. In some cases, the torque sensor module 100 may be applied to robot joints involving multi-axis (e.g., six-axis) force or torque control, such as in a neck or wrist, to enable precise control of such force or torque.

As described above, the present invention has been explained with reference to specific components, limited embodiments, and drawings, which are provided solely to aid in a comprehensive understanding of the invention. However, the invention is not limited to these embodiments. Various modifications and alterations may be made by those skilled in the art without departing from the essential characteristics of the invention. Accordingly, the scope of the invention should not be construed as being limited to the disclosed embodiments, and all technical ideas that are equivalent or substantially similar to the claims set forth below should be interpreted as falling within the scope of the invention.

1. A calibration method in an apparatus for analyzing an operation of a torque sensor module, comprising:
receiving, in response to an input torque, sensing voltages from a plurality of strain gauges mounted on the torque sensor module, wherein each sensing voltage is obtained from a contact point of a pair of strain gauges attached at respective positions and connected in series;
calculating a differential component having first difference values between a reference voltage and each of the sensing voltages and second difference values for each of two combinations of the sensing voltages;
calculating a calibration gain corresponding to the input torque and the differential component; and
applying the calibration gain to a circuitry of the torque sensor module to calculate a torque received by the torque sensor module based on the calibration gain.

2. The calibration method of claim 1, wherein the input torque comprises a value for one or more forces or torques along the three axes of a rectangular coordinate system.

3. The calibration method of claim 1, wherein, in the calculating the calibration gain, the calibration gain is calculated to satisfy T−AS=k, where T is the input torque, A is the calibration gain, S is the differential component, and k is zero or a real value predetermined for calibration.

4. The calibration method of claim 1, wherein the calibration gain is determined based on a result of regression analysis or neural network learning, performed while varying values of the input torque, such that the calibration gain satisfies a predetermined minimum value.

5. A torque sensor module circuit, comprising:
a reference voltage generator;
a memory configured to store a calibration gain;
a torque detector configured to:
receive sensing voltages from a plurality of strain gauges mounted on a torque sensor module, wherein each sensing voltage is received from a contact point of a pair of strain gauges attached at respective positions and connected in series;
calculate a differential component having first difference values between a reference voltage from the reference voltage generator and each of the sensing voltages, and second difference values for each of two combinations of the sensing voltages; and
calculate a torque corresponding to the differential component and the calibration gain; and
a torque controller configured to generate a command for torque control based on the calculated torque,
wherein the calibration gain is pre-calculated to correspond to the input torque and the differential component for each of the sensing voltages in the torque sensor module for a predetermined input torque and stored in the memory.

6. The torque sensor module circuit of claim 5, wherein the torque sensor module comprises:
a body in which a first sensitivity adjustment hole, a strain measurement hole, a second sensitivity adjustment hole, and a stiffness adjustment hole are repeatedly formed along a circumferential direction between a central hole and an outer circumferential surface,
wherein the strain measurement hole, to which the pair of strain gauges are attached, has a trapezoidal shape with a side closer to the center having a greater length than a side closer to the outer circumferential surface.
